(19) United States
(12) Patent Application Publication
(10) Pub. No.: US 2013/0153260 A1
(43) Pub. Date: Jun. 20, 2013

(54) ESP Power Cables

(71) Applicant: E I DU PONT DE NEMOURS AND COMPANY, Wilmington, DE (US)

(72) Inventors: Daniel A. Favereau, Chambesy (CH); Jeanne Driebeek, Onex (CH); Marco Ang, Troinex / GE (CH)

(73) Assignee: E I DU PONT DE NEMOURS AND COMPANY, Wilmington, DE (US)

(21) Appl. No.: 13/715,011

(22) Filed: Dec. 14, 2012

Related U.S. Application Data
(60) Provisional application No. 61/577,368, filed on Dec. 19, 2011.

(51) Int. Cl. H01B 7/18; H01B 9/00

(52) U.S. Cl. CPC H01B 7/18; H01B 9/006
USPC 174/102 C

(57) ABSTRACT

An electrical submersible pump (ESP) power cable for use in oil wells is provided, comprising at least two electrical conductors, a first fluoropolymer layer surrounding each of the at least two electrical conductors, an outer metal armouring, wherein the first fluoropolymer layer surrounding each of the at least two electrical conductors is composed of at least one fluoropolymer chosen among ETFE (ethylene tetrafluoroethylene copolymer), PFA (perfluoroalkoxy copolymer), FEP (fluorinated ethylene propylene copolymer) and/or mixtures thereof.

### FIELD OF THE INVENTION

The present invention relates to power cables for use with submersible pumps used in oil wells, and in particular to power cables that are resistant to both hydrogen sulfide gas, exposure to high temperatures, wet electrical treeing and rapid gas decompression.

### BACKGROUND OF THE INVENTION

This invention concerns electrical submersible pump power cables, commonly referred to as ESP power cables, used to power downhole electrical motors for submersible pumps in oil wells. Submersible pumps provide an economical method of pumping large volumes of production fluids from wells that are often several thousand meters deep and often under high temperatures and pressures. The production fluids found in these wells will often contain large amounts of dissolved gases such as methane, carbon dioxide and hydrogen sulfide. Power cables used to power these pumps must be specifically designed to withstand exposure to these gases and to the damaging effects of decompression which occurs when the pressure within the well is rapidly reduced such as when the submersible pump and power cable are pulled to the surface for servicing, or in the event of a sudden explosive decompression during for example a blow-out.

U.S. Pat. No. 5,414,217 to Neuroth and Wallace discloses an ESP power cable wherein the insulation in direct contact with the electrical conductor is polypropylene, polyethylene, ethylene/propylene diene monomer terpolymer (EPDM), cross-linked polyethylene (XLPE), or silicone rubber. A low permeable layer surrounds the insulation layer. The low permeable layer is 0.004 to 0.010 inches thick and is composed of fluorocarbon polymer, PEEK or polyimide. A lead tape layer surrounds the low permeable layer. Multiple of these lead tape-sheathed conductors are embedded within an elastomer jacket, and this jacket is sheathed in outer metal armour.

US2010/0147505 (U.S. Pat. No. 8,113,273) to Manke et al. discloses an ESP power cable wherein the insulation in contact with the electrical conductors is polyimide tape. A second insulating layer is present over the polyimide tape, this second layer being fluoropolymer. A protective sheath is disposed over the insulating layer, this sheath being composed of stainless steel, MONEL®, carbon steel, or lead. The resultant insulated, sheathed conductors are wrapped together by tape armouring composed of metal or non-metallic material.

U.S. Pat. No. 5,426,264 to Livingston, Neuroth and Korte discloses an ESP power cable having an insulation layer of XLPE surrounding the copper conductor, where no lead layer is employed. However, the XLPE offers poor protection against hydrogen sulfide and therefore needs to be protected by an additional layer, which is a barrier layer. The barrier layer is composed of fluoropolymers or non-fluoropolymers. An adhesive interlayer between the XLPE insulation layer and barrier layer is necessary to prevent gas pockets forming between the insulating layer and the barrier layer during rapid gas decompression, which could rupture the barrier layer. Multiple insulated, adhesive layer, barrier layer assemblages are embedded in rubber protective layer, which is then sheathed by metal armour tape.

These ESP power cables suffer from one or more of the problems of the economic disadvantage of cumbersome manufacture, excessive cost, excessive rigidity, excessive weight, excessive size, and/or inability to withstand the combination of the presence of H₂S in the high temperature oil well environment and decompression. With respect to the problems of H₂S penetration into the cable and decompression of the cable, low molecular weight gases such as H₂S permeate the insulation within the cable within the well until the pressure of the dissolved gases in the intermolecular spaces of the insulation and the pressure of the gases in the well fluid reach equilibrium. When decompression occurs, the pressure outside the cable is reduced, causing the dissolved gases inside the insulation to expand to re-establish equilibrium at the lower pressure.

The rate of pressure change within the cable depends on many variables such as reservoir characteristics of the insulation and the rate of decompression, such as depending on pull rate of the cable from the well. A rapid reduction in pressure can easily damage the power cable insulation, i.e. the insulation is decompression sensitive. When the pressure is reduced, the dissolved gases tend to expand to re-establish equilibrium, just as when the pressure is relieved when opening a soda bottle. If the pressure change is rapid enough, the decompression sensitivity takes the form of bubbles forming inside the insulation causing microscopic tears in the insulation. In some cases, decompression can be so severe as to cause holes to “blow out” in the insulation, rendering the cable electrically useless. Insulations made of polyimide, cross-linked polyethylene, polypropylene and EPDM do not provide the protection of the electrical conductor from H₂S and decompression insensitivity in the sense of retained integrity as insulation after decompression.

What is needed is a high temperature resistant power cable for electrical submersible pumps which is more resistant to aggressive well gasses but which is lighter and thinner than conventional lead covered cables, is exceptionally resistant to fatigue, is easily manufactured, repaired or spliced, economically advantageous, and is less inclined to rupture from internal gas pressure during decompression.

### SUMMARY OF THE INVENTION

The present invention provides for an electrical submersible pump (ESP) power cable for use in oil wells comprising, consisting essentially of, or consisting of, at least two electrical conductors, a first fluoropolymer layer surrounding each of the at least two electrical conductors, an outer metal armouring, wherein the first fluoropolymer layer surrounding each of the at least two electrical conductors comprises, and preferably consists essentially of or consists of, at least one fluoropolymer chosen among ETFE (ethylene tetrafluoroethylene copolymer, PFA (perfluoroalkoxy copolymer), FEP (fluorinated ethylene propylene copolymer) and/or mixtures thereof. The outer metal armouring is effective to protect the cable during handling and to maintain its integrity in use within the oil well, i.e. to provide resistance to crushing under the high pressures encountered within the well. The fluoropolymer layer surrounding each of the electrical conductors, while limiting the exposure of the conductors to low molecular weight gases including H₂S, nevertheless becomes saturated with H₂S and other small molecule gases such as methane. Nevertheless, the fluoropolymer layer is insensitive to decompression, i.e. the layer does not swell as indicated by the decompression not causing the fluoropolymer layer to internally tear and bubble. The layer retains its original thickness. This is surprising, considering the thickness of the fluoropolymer layer, which is typically at least 15 mils (0.38 mm), up to 1.5 or 2 mm.

The insulation effectiveness of the fluoropolymer layer in withstanding rapid decompression enables the power cable to be smaller in cross-section, thus reducing weight and occupied space within the oil well. This advantage of weight reduction is enhanced by the outer metal armouring not being lead. This weight reduction is significant in enabling the power cable to be used in long lengths within the oil well, e.g. 3 000 meters in length and longer. Weight reduction of more than 50% has been achieved by the power cable of the present invention.

The following are preferences for the components of the above electrical submersible pump power cable for use of the present invention, which can be used individually or in any combination in the cable:
The at least one fluoropolymer has a melt flow index of from 0.5 g/10 min to 10 g/10 min, as measured according to ISO 12086;
The fluoropolymer of said first fluoropolymer layer has a stress crack resistance in excess of 10 000 cycles, preferably at least 20 000 cycles, when measured according to ASTM D 2176;
The first fluoropolymer layer is in direct contact with each of the electrical conductors, thereby making this first fluoropolymer layer the primary insulation of the conductors;
The first fluoropolymer layer is in direct contact with each of said electrical conductors and preferably, with said outer metal armouring;
The first fluoropolymer layer has a second fluoropolymer layer surrounding said first fluoropolymer layer;
The fluoropolymer of said second fluoropolymer layer comprises the same fluoropolymer of which said first fluoropolymer is comprised;
The first and second fluoropolymer layers are in direct contact with one another; and/or
An additional padding layer is intercalated between the first fluoropolymer layer and the outer metal armouring. When the second fluoropolymer layer is present in the cable, the padding layer is intercalated between the second fluoropolymer layer and the outer armouring. The presence of the additional padding layer is preferred for providing protection of the first fluoropolymer layer when by itself and of the second fluoropolymer layer when both fluoropolymer layers are present from injury if in direct contact with the outer metal armouring.

In a further embodiment, the present invention provides for an electrical submersible pump (ESP) power cable for use in oil wells comprising, consisting essentially of, or consisting of, at least two electrical conductors, a first fluoropolymer layer surrounding each of the at least two electrical conductors and a second fluoropolymer layer surrounding the first fluoropolymer layer, and an outer metal armouring, wherein the first fluoropolymer layer surrounding each of the at least two electrical conductors comprises, consists essentially of, or consists of at least one fluoropolymer chosen among ETFE (ethylene tetrafluoroethylene copolymer, PFA (perfluoroalkoxy copolymer), FEP (fluorinated ethylene propylene copolymer) and/or mixtures thereof; and further wherein the second fluoropolymer layer surrounding the first fluoropolymer layer comprises, consists essentially of, or consists of at least one fluoropolymer chosen among ETFE (ethylene tetrafluoroethylene copolymer, PFA (perfluoroalkoxy copolymer), FEP (fluorinated ethylene propylene copolymer) and/or mixtures thereof.

Each of the preferences mentioned above are applicable to this embodiment. In this regard, the preferences with respect to melt flow index and stress crack resistance apply to both fluoropolymer layers. The preference for direct contact between first fluoropolymer layer and electrical conductors applies to this embodiment of two fluoropolymer layers being present in the cable. It is also preferred that the second fluoropolymer layer is in direct contact with the first fluoropolymer layer. While the first fluoropolymer layer cannot be in direct contact with the outer metal armouring, the second fluoropolymer layer can have this direct contact. In this further embodiment, the additional padding layer is intercalated between the second fluoropolymer layer and the outer metal armouring. The fluoropolymers of which the first and second fluoropolymer layers are comprised are preferably the same in each layer.

### BRIEF DESCRIPTION OF THE DRAWINGS

FIG. 1a shows in cross-section one embodiment of the first fluoropolymer layer forming the primary insulation on an electrical conductor;

FIG. 1b shows in cross-section another embodiment of the first fluoropolymer layer forming the primary insulation on an electrical conductor;

FIG. 2a shows in cross-section the embodiment of FIG. 1a as a bundle of a plurality of insulated conductors:

FIG. 2b shows in cross-section another embodiment of a plurality of insulated conductors;

FIG. 3a shows in cross-section one embodiment of a plurality of electrical conductors insulated with first and second layers of fluoropolymer;

FIG. 3b shows in cross-section another embodiment of a plurality of electrical conductors insulated with first and second layers of fluoropolymer;

FIG. 4a shows in cross-section one embodiment of ESP power cable of the present invention;

FIG. 4b shows in cross-section another embodiment of ESP power cable of the present invention;

FIG. 5a shows in cross-section still another embodiment of ESP power cable of the present invention: and

FIG. 5b shows in cross-section still another embodiment of ESP power cable of the present invention.

### DETAILED DESCRIPTION OF THE INVENTION

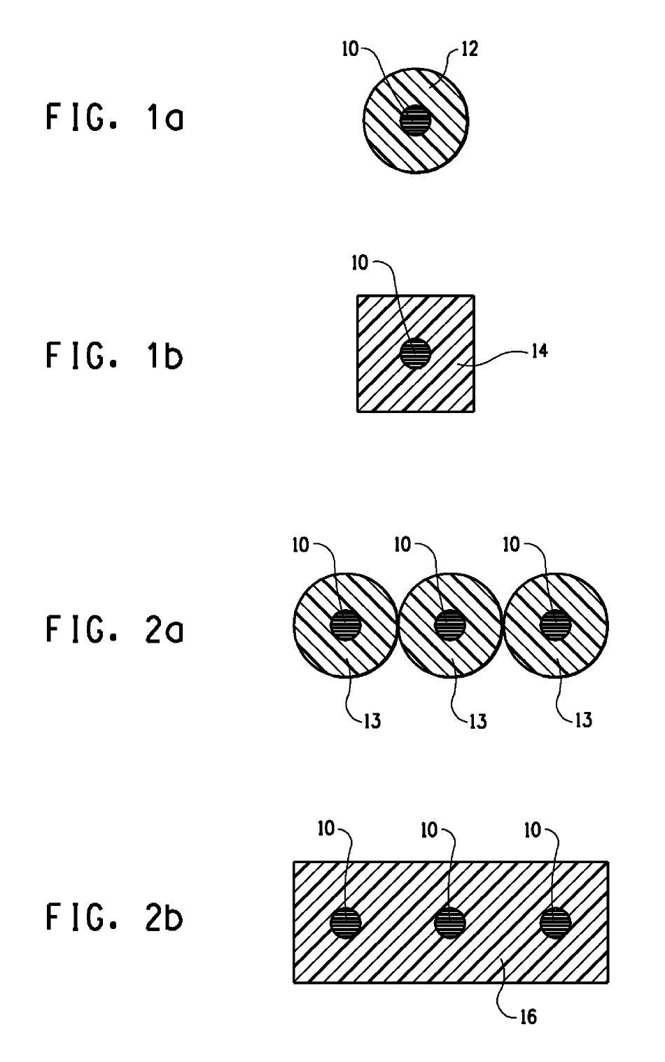

In FIG. 1a, an electrical conductor 10 is surrounded by a circular first fluoropolymer layer 12.

In FIG. 1b, the electrical conductor 10 is surrounded by a square first fluoropolymer layer 14.

In FIG. 2a, a bundle of three electrical conductors 10 each surrounded by a discrete circular first fluoropolymer layer 13.

In FIG. 2b, a bundle of three electrical conductors 10 is surrounded by a contiguous rectangular first fluoropolymer layer 16. In this embodiment, the first layer of fluoropolymer 16 is a unitary layer surrounding each of the conductors 10.

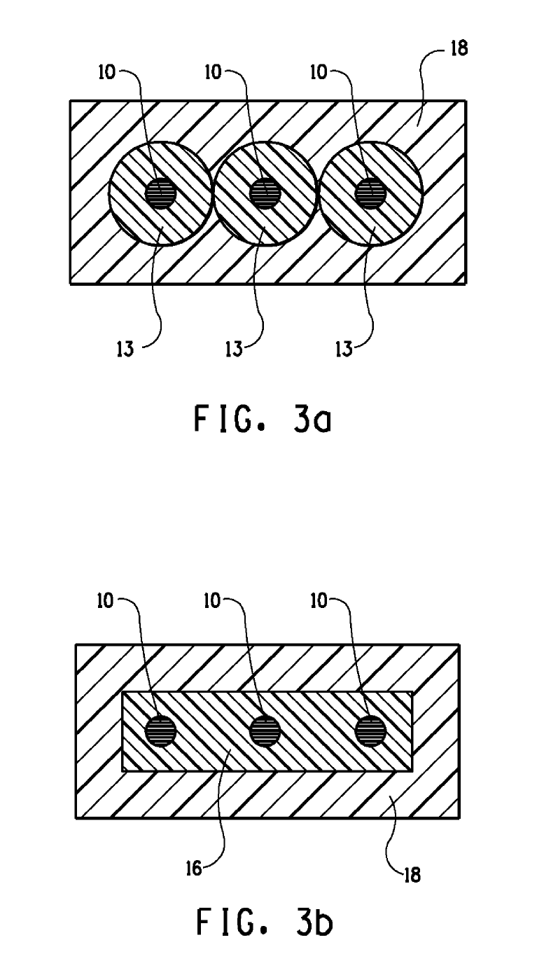

In FIG. 3a, three electrical conductors 10 are each surrounded by a discrete circular first fluoropolymer layer 13 and a rectangular contiguous second fluoropolymer layer 18.

In FIG. 3b, three electrical conductors 10 are each surrounded by a contiguous rectangular first fluoropolymer layer 16 and a contiguous second fluoropolymer layer 18.

Preferably, the combined thicknesses of the first and second fluoropolymer layers form the primary insulation on the electrical conductors, i.e. the thickness of insulation required to provide the necessary dielectric effect of the insulation. When just the first fluoropolymer layer is present as in FIGS. 1a and 1b and in FIGS. 2a and 2b, the thickness of this single layer will be such as to provide the necessary dielectric effect. Thus, for example, the thickness of layer 12 in FIG. 1a will have to be equal to the combined thickness of layers 13 and 18 of FIG. 3a to provide the same dielectric effect.

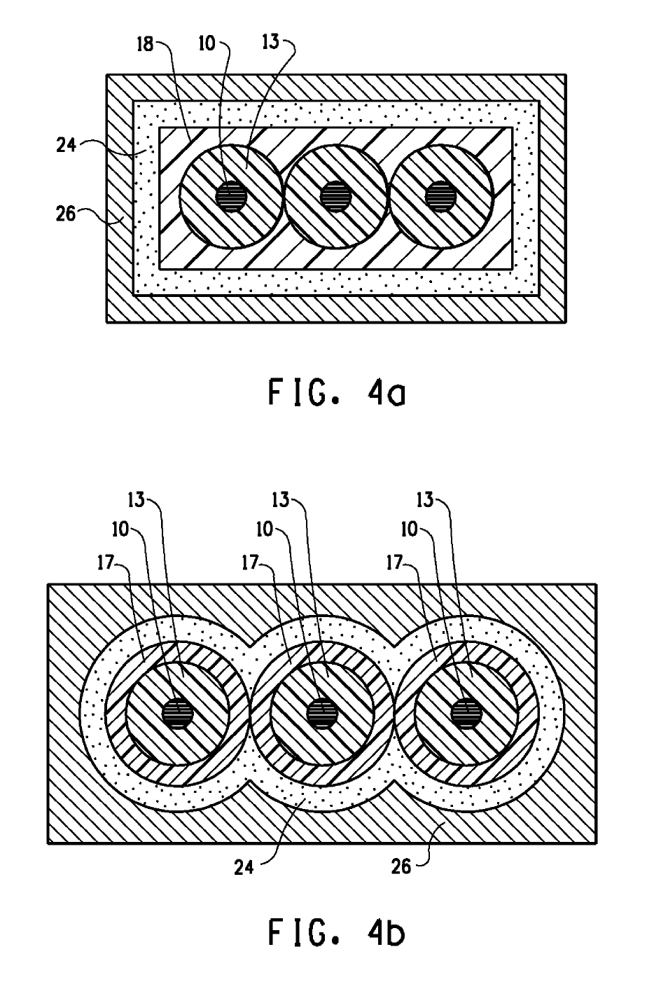

In FIG. 4a, a bundle of three electrical conductors 10 is surrounded by a discrete circular first fluoropolymer layer 13 and a rectangular contiguous second fluoropolymer layer 18, a padding layer 24 and a metal armouring 26.

In FIG. 4b, a bundle of three electrical conductors 10, i.e. each conductor, is surrounded by a discrete circular first fluoropolymer layer 13 and a discrete circular contiguous second fluoropolymer layer 17, a padding layer 24 and a metal armouring 26.

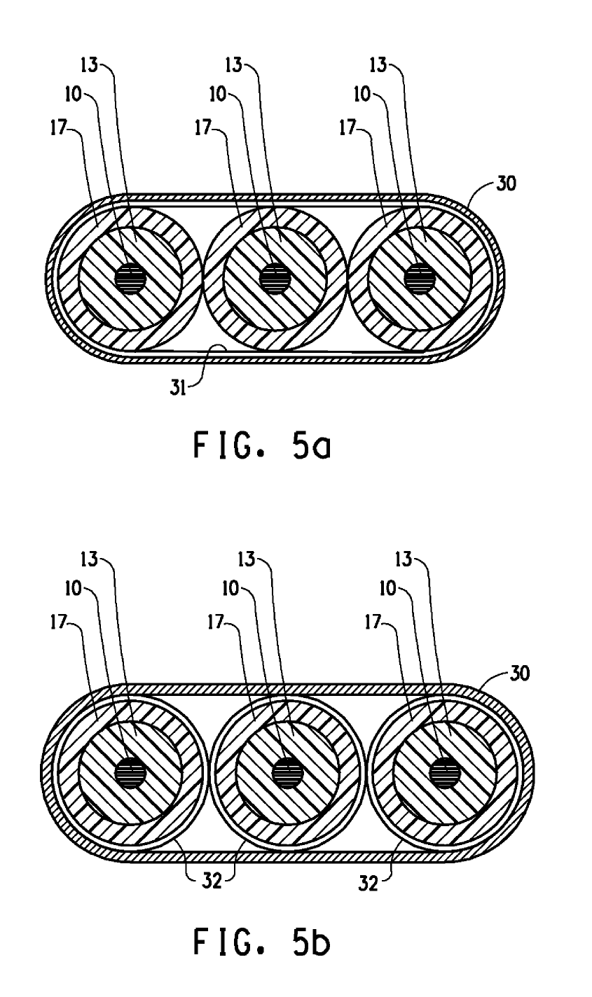

In FIG. 5a, each of the three electrical conductors 10, is surrounded by a discrete circular first fluoropolymer layer 13 and a discrete circular contiguous second fluoropolymer layer 17. In this embodiment, a padding layer 31 and a metal armouring 30 each surround the bundle of three insulated electrical conductors 10. The padding layer in this embodiment is unitary in the sense of a single layer wrapping around the insulated conductors 10. The padding layer and metal armouring bridge the unoccupied space between the insulated conductors.

In FIG. 5b, each of the three electrical conductors 10, is surrounded by a discrete circular first fluoropolymer layer 13 and a discrete circular contiguous second fluoropolymer layer 17. In this embodiment, a discrete padding layer 32 surrounds each of the insulated conductors 10, and a metal armouring 30 surrounds the bundle of three insulated electrical conductors 10 and bridges the unoccupied space between the padded, insulated conductors 10.

In FIGS. 5a and 5b, the metal armouring 30 is a spirally wound “S” shaped and interlocked metal tape applied under controlled tension to the underlying unitary padding layer (FIG. 5a) and discrete padding layers (FIG. 5b) As shown in the Figures, the surrounding of the electrical conductor(s) by fluoropolymer layers involves the embedding of the conductor within the first fluoropolymer layer, and the embedding of the first fluoropolymer layer within the second fluoropolymer layer. In the embodiment of FIG. 3b, the first fluoropolymer layer is entirely enveloped within the second fluoropolymer layer. The same would be true if the insulated conductors 10/13 of FIG. 3a were spaced apart. In the embodiment shown in FIG. 3a, the envelopment is complete except for a line of contact between adjacent insulated conductors 10/13. This same relationship exists between insulated conductors 10/13/17 and the padding layer 24 in FIG. 4b. Nevertheless, the second layer 18 of FIG. 3a and the padding layer 24 of FIG. 4b surround their respective insulated conductors 10/13 and 10/13/17.

For the purpose of the present disclosure, the term “direct contact” denotes a point or area of contact between two parts that is essentially void of any intervening material. The direct contact of the first layer of fluoropolymer with the electrical conductor makes this layer the primary insulation of the power cable when no second fluoropolymer layer is present. The direct contact of the second fluoropolymer layer, when present, with the first fluoropolymer layer makes this combination of layers the primary insulation of the cable.

For the purpose of the present disclosure, “ethylene tetrafluoroethylene copolymers” are polymers that as described in ASTM D 3159.

For the purpose of the present disclosure, “perfluoroalkoxy copolymers” are polymers as described in ASTM D 3307.

For the purpose of the present disclosure, “fluorinated ethylene propylene copolymers” are polymers as described in ASTM D 2116.

The electrical submersible pump (ESP) power cable for use in oil according to the present invention comprises of at least two electrical conductors, a first fluoropolymer layer surrounding each of the at least two electrical conductors, an outer metal armouring, wherein the first fluoropolymer layer surrounding each of the at least two electrical conductors comprises of at least one fluoropolymer chosen among ETFE (ethylene tetrafluoroethylene copolymer, PFA (perfluoroalkoxy copolymer), FEP (fluorinated ethylene propylene copolymer) and/or mixtures thereof.

The electrical conductors of the present invention may be chosen among any material that can conduct electrical current. Preferably, the electrical conductors may be chosen among metals such as silver, copper, aluminum, steel, tin, iron, lead and alloys thereof. More preferably, the material is copper or aluminum, most preferably copper and alloys thereof.

The electrical conductors may each be present in a solid form, such for example in drawn wire, also called solid-core or single-strand wire, or in stranded form, such as for example in stranded or braided wire. Preferably, the electric conductors are present in the form of drawn wires.

The electrical conductors of the electrical submersible pump (ESP) power cable for use in oil wells according to the present invention are insulated with a first fluoropolymer layer surrounding each electrical conductor.

The first fluoropolymer layer surrounding the electrical conductors must be resistant to cracking to allow for a cable that can be installed and removed multiple times, even at low temperatures, without the layer cracking or becoming brittle. Furthermore, the first fluoropolymer layer should preferably be able to withstand temperatures of at least or in excess of 200° C. for extended time periods, or stated alternatively, it preferably has a service temperature of at least or in excess of 200° C.

The term “service temperature” as used in the present application refers to the service temperature as described in ISO 2578 for 20 000 h.

The fluoropolymers of the first fluoropolymer layer surrounding the electrical conductors preferably have a stress crack resistance in excess of 10 000 cycles or from 10 000 cycles to 30 000 cycles, more preferably in excess of 20 000 or 30 000 cycles or from 20 000 or 30 000 cycles to 100 000 cycles when measured according to ASTM D 2176 on a Tinius Olsen MIT flex testing apparatus set to a load of 2.5 lbs. and using a sample having a thickness of 0.2±0.01 mm. These stress crack results are often referred to as MIT flex life. The use of the power cable within the oil well does not involve these many cycles of flexing. It has been found, however, that high MIT flex life leads to crack free insulation in the power cable. Apparently, the temperature/pressure environment, including temperature and pressure fluctuations, impose conditions on the cable insulation that manifest themselves by cracking of the insulation, the same as occurs in the MIT flex life test.

Preferably, the fluoropolymers of the first fluoropolymer layer according to the present invention are fluoropolymers having a melt flow index of from 0.5 g/10 min to 10 g/10 min as measured according to ISO 12086, more preferably of from 1 g/10 min to 6 g/10 min. The conditions of melt temperature and weight (on the molten polymer) used in this test will depend on the fluoropolymer being tested and are specified, for example in the ASTM test procedures for the specific fluoropolymer. As specified in ASTM D 2116 and ASTM D 3307 for fluorinated ethylene/propylene copolymer and perfluoroalkoxy copolymer, respectively, the test temperature is 372° C. and the weight is 5 kg. It has been found that as melt flow index increases from 6 g/10 min, the resistance of the cable insulation to cracking within the power cable decreases. This limits the utility of the power cable to wells characterized by milder temperature and pressure fluctuations, to the extent these fluctuations can be controlled. It is preferred that the melt flow index of the fluoropolymer not be greater than 10 g/10 min so that the insulation and thus the power cable can be expected to retain its integrity during use in the oil well.

The fact the fluoropolymers have a melt flow index means that they are melt flowable. Preferably they are also melt fabricable so as to be melt extrudable around the electrical conductor or the second fluoropolymer layer around the first fluoropolymer layer to form tough layers as indicated by the stress crack resistance for the fluoropolymers as described above.

These preferences for stress crack resistance and melt flow index apply to each fluoropolymer described below.

Suitable fluoropolymers may be chosen among ETFE (ethylene tetrafluoroethylene copolymer), PFA (perfluoroalkoxy copolymer), FEP (fluorinated ethylene propylene copolymer) and/or mixtures thereof, and more preferably PFA (perfluoroalkoxy copolymer), FEP (fluorinated ethylene propylene copolymer) and/or mixtures thereof

The fluoropolymer ETFE (ethylene tetrafluoroethylene copolymer) is generally a copolymer of ethylene and tetrafluoroethylene. In the ESP power cables of the present invention, the ETFE surrounding the conductors may be chosen among ETFEs comprising of from 15 weight percent to 25 weight percent of ethylene and of from 75 weight percent to 85 weight percent of tetrafluoroethylene, more preferably of from 15 weight percent to 20 weight percent of ethylene and of from 80 weight percent to 85 weight percent of tetrafluoroethylene, based on the total weight of the ETFE.

The fluoropolymer PFA (perfluoroalkoxy copolymer) is generally a copolymer of tetrafluoroethylene and a perfluoroalkylvinylether such as perfluoropropylvinylether, perfluoroethylvinylether or perfluoromethylvinylether. In the ESP power cables of the present invention, the PFA surrounding the conductors may be chosen among PFA comprising of from 90 weight percent to 98 or 99 weight percent of tetrafluoroethylene and of from 1 or 2 weight percent to 10 weight percent of perfluoropropylvinylether, perfluoroethylvinylether or pertluoromethylvinylether, more preferably of from 92 weight percent to 97 weight percent of tetrafluoroethylene and of from 3 weight percent to 8 weight percent of perfluoropropylvinylether, perfluoroethylvinylether or pertluoromethylvinylether, all based on the total weight of the PFA.

The fluoropolymer FEP (fluorinated ethylene propylene copolymer) is generally a copolymer of tetrafluoroethylene and hexafluoropropylene. In the ESP power cables of the present invention, the FEP surrounding the conductors may be chosen among FEPs comprising of from 87 weight percent to 94 weight percent of tetrafluoroethylene and of from 6 weight percent to 13 weight percent of hexafluoropropylene, more preferably of from 88 weight percent to 90 weight percent of tetrafluoroethylene and of from 10 weight percent to 12 weight percent hexafluoropropylene, all based on the total weight of the FEP. More preferably, the FEP surrounding the conductors may be chosen among FEPs further comprising no more than 2 weight percent or from 0.01 weight percent to 2 weight percent of an additional fluoromonomer other than tetrafluoroethylene or hexafluoropropylene, based on the total weight of the copolymer.

The fluoropolymer of which the first layer of fluoropolymer is comprised is preferably a perfluoropolymer, i.e. a fluoropolymer wherein all the monovalent substituents on the carbon atoms of the fluoropolymer chain, with the exception of end groups, are fluorine atoms. PFA and FEP are perfluoropolymers that have service temperatures of 260° C. and 205° C., respectively.

The first fluoropolymer layer surrounding the electrical conductors may have a thickness of from 0.1 mm to 2 mm, more preferably of from 0.5 mm to 1.5 mm or from 1 mm to 2 mm. Typically, the first polymer layer will have a thickness of at least 0.38 mm and up to a maximum thickness of 1.5 mm or 2 mm.

The first fluoropolymer layer surrounding the electrical conductors may have a circular, oval, rectangular, square or other complex outline. In the case of non-circular first fluoropolymer layer, these layer thicknesses apply to the thinnest thickness of the layer.

Preferably, the first fluoropolymer layer surrounding the electrical conductors has a circular or rectangular shape, and preferably has a circular shape.

These thicknesses and cross-sectional shape of the first fluoropolymer layer applies to such layers comprising each of the fluoropolymers described above.

The electrical conductors each may have a circular cross-section and a cross-sectional surface of, for example, 13.3 mm² or 16 mm². Preferably the electrical conductors may have a cross-sectional surface of from 6 mm² to 20 mm² and more preferably of from 10 mm² to 20 mm². These electrical conductors and their constructions as described above can be used with any of the fluoropolymers described above from which the first fluoropolymer layer is comprised.

In the ESP power cable according to the present invention, the electrical conductors are surrounded by a first fluoropolymer layer, which may be contiguous or not contiguous.

In the case where the first fluoropolymer layer is contiguous, each of the conductors is surrounded by the same, singular, monolithic first fluoropolymer layer, i.e. each conductor shares the same fluoropolymer jacket or sheath as insulation.

In the case where the first fluoropolymer layer is not contiguous, each of the conductors is surrounded separately by a discrete first fluoropolymer layer, i.e. each conductor has a separate fluoropolymer jacket or sheath as insulation.

Preferably, the first fluoropolymer layer is not contiguous, and each conductor has a separate fluoropolymer jacket or sheath as insulation.

The first fluoropolymer layer surrounding the electrical conductors is preferably applied to the electrical conductor by known methods such as pressure melt extrusion or tubing melt extrusion.

The first fluoropolymer layer is preferably in direct contact with the electrical conductors, thereby forming the primary insulation of the power cable, and is more preferably in direct contact with the electrical conductors and the outer metal armouring.

These relationships between first layer insulations and between such insulations and the electrical conductor can be used with any of the fluoropolymers described above from which the first fluoropolymer layer is comprised.

To form the ESP power cable according to the present invention, at least two electrical conductors surrounded by a first layer of fluoropolymer (of any of the fluoropolymers described above) are combined into a bundle and encased in an outer metal armouring.

The bundle may have a polygonal shape, such as for example in the case where the bundle consists of three electrical conductors, the three electrical conductors being spaced by 120° angle with respect to each other and the three electrical conductors forming the corners of an equilateral triangle. The bundle may also have a flat shape, with each of the at least two electrical conductors being placed side-by-side in one plane.

Preferably, the bundle has a flat shape.

The outer metal armouring of the ESP power cable of the present invention is generally of a metal or metal alloy, and is necessary to protect the ESP power cable against abrasion, mechanical impact, puncture, and compression (crushing). It accomplishes this protection by surrounding the insulated conductors as a housing for these conductors and by the metal, includes metal alloy, having the necessary strength, which depends on the particular metal used, its shape, and thickness. Suitable metals for the metal armouring may be chosen among steel, CrMo steel, aluminum, copper, brass, carbon steel, stainless steel, and/or MONEL®. The outer metal armouring preferably does not contain lead, i.e. is lead free

The outer metal armouring is preferably formed by of a continuous metal tape helically (spirally) wound and interlocked into a closed cylinder around the at least two electrical conductors, each insulated by at least one fluoropolymer layer. Preferably, the thickness of the metal armouring, including when the armouring is metal tape, is at least 10 mils (0.25 mm)

The ESP power cable according to the present invention preferably includes an additional padding layer as an additional layer within the power cable that is intercalated between the first fluoropolymer layer and the outer metal armouring, and may comprise glass, asbestos or rock wool fibers, polymeric materials, braided or woven metal fabric, and or combinations thereof. Preferably, the additional padding layer is a polymeric padding layer. Preferably the padding layer surrounds the first fluoropolymer layer.

Suitable polymeric materials useful in the additional polymeric padding layer may be chosen among polyesters, polyamides, aramides, fluoropolymers, polyolefins and/or combinations thereof.

Preferably, the additional polymeric padding layer may be chosen among polymers having a service temperature of at least 200° C. and preferably an excellent chemical resistance, to cope with the conditions encountered in an oil well such as aggressive and highly pressurized gasses like H₂S and CO₂ and temperatures in excess of 200° C.

The additional polymeric padding layer is preferably present in the form of a woven or non-woven fabric of polyesters, polyamides, aramides, fluoropolymers, polyolefins and/or combinations thereof and is preferably present in the form of a non-woven fabric, such as for example meltblown polyolefin, PTFE skived tape, or flashspun olefin non-woven fabrics, wrapped around the first fluoropolymer layer. The other padding materials from which the padding layer can be composed as described above can also be in these textile forms.

The additional padding layer, such as the polymeric padding layer, acts as a cushion in which the underlying power cable components are wrapped and allows the fluoropolymer layer to expand to a certain degree during thermal expansion when the cable is heated by hot oil in the oil well, without putting excessive damaging pressure on the fluoropolymer layer from the inside of the metal armouring, especially when the armouring is wound metal tape. Thus, the material used to form the padding layer is in a form such as the fabric described above, whereby the padding layer is compressible. The padding layer is therefore preferably not a solid filler, filling up the space between the first fluoropolymer layer and outer armouring with solid material such as solid polymer. The surrounding of the first fluoropolymer layer and thus the insulated conductors by the padding layer makes this layer compressible in all cross-wise directions, such as up, down, or sideways with respect to the cable cross-sections shown in FIGS. 4a and 4b.

In a further embodiment, the electrical submersible pump (ESP) power cable for use in oil wells according to the present invention comprises at least two electrical conductors, a first fluoropolymer layer surrounding each of the at least two electrical conductors, a second fluoropolymer layer surrounding the first fluoropolymer layer, and an outer metal armouring, wherein the first fluoropolymer layer surrounding each of the at least two electrical conductors comprises at least one fluoropolymer chosen among ETFE (ethylene tetrafluoroethylene copolymers, PFA (perfluoroalkoxy copolymers), FEP (fluorinated ethylene propylene copolymers) and/or mixtures thereof, and wherein the second fluoropolymer layer surrounding the first fluoropolymer layer comprises at least one fluoropolymer chosen among ETFE (ethylene tetrafluoroethylene copolymer, PFA (perfluoroalkoxy copolymer), FEP (fluorinated ethylene propylene copolymer) and/or mixtures thereof.

In the electrical submersible pump (ESP) power cable for use in oil wells according to the present invention comprising of at least two electrical conductors, at least one of the two fluoropolymer layers is preferably pigmented or otherwise colored in order to distinguish the different fluoropolymer layers between each other. The electrical conductors of the electrical submersible pump (ESP) power cables for use in oil wells according to this embodiment of the present invention are insulated with a first and a second fluoropolymer layer surrounding each electrical conductor, wherein the second fluoropolymer layer surrounds the first fluoropolymer which itself surrounds each electrical conductor.

Preferably, the first fluoropolymer layer is in direct contact with the electrical conductors and the second fluoropolymer layer, and the second polymer layer is in direct contact with the first fluoropolymer layer. Preferably the second fluoropolymer layer is in direct contact with the outer metal armouring and more preferably with a padding layer surrounding the second fluoropolymer layer and which is in direct contact with the metal armouring.

Suitable fluoropolymers of the first and second fluoropolymer layer of the electrical submersible pump (ESP) power cable may independently be chosen among ETFE (ethylene tetrafluoroethylene copolymer), PFA (perfluoroalkoxy copolymer), FEP (fluorinated ethylene propylene copolymer) and/or mixtures thereof, more preferably from PFA (perfluoroalkoxy copolymer), FEP (fluorinated ethylene propylene copolymer) and/or mixtures thereof, as described above.

The fluoropolymers of the first and second fluoropolymer layer should preferably be resistant to fatigue to allow for a cable that can repeatedly be bent, even at low temperatures, without cracking or becoming brittle. Furthermore, the fluoropolymers of the first and second fluoropolymer layer should preferably be able to withstand temperatures at least or in excess of 200° C. or of from 200 to 260° C. and even at least or in excess of 260° C., for extended time periods. Stated alternatively, they should preferably have a service temperature in excess of at least or in excess of 200° C. or of from 200 to 260° C.

Preferably, the fluoropolymers of the first and second fluoropolymer layer according to the present invention are comprised of fluoropolymers having a melt flow index of from 0.5 g/10 min to 10 g/10 min as measured according to ISO 12086, more preferably of from 1 g/10 min to 6 g/10 min as described above. The second fluoropolymer is also comprised of fluoropolymer that satisfies the stress crack resistance parameters described above with reference to the first fluoropolymer layer.

Suitable fluoropolymers of the first and second fluoropolymer layer may be independently chosen among ETFE (ethylene tetrafluoroethylene copolymer, PFA (perfluoroalkoxy copolymer), FEP (fluorinated ethylene propylene copolymer) and/or mixtures thereof, more preferably PFA (perfluoroalkoxy copolymer), FEP (fluorinated ethylene propylene copolymer) and/or mixtures thereof. The fluoropolymers comprising the first and second fluoropolymer layers are preferably not fluoroelastomers. FEP, PFA, and ETFE are not fluoroelastomers.

The first fluoropolymer layer and the second fluoropolymer layer may be of the same fluoropolymer or may be of different fluoropolymers.

Preferably, the first fluoropolymer layer and the second fluoropolymer layer are of the same fluoropolymer. Preferably, these first and second layers have the same dielectric characteristic.

This embodiment provides enhanced resistance against failure by the formation of cracks and/or puncturing. This enhanced resistance arises from the superposition of two thinner fluoropolymer layers such as the first and second fluoropolymer layer, instead of using one thicker fluoropolymer layer as the primary insulation for the electrical conductors. Cracks, even microscopic cracks, formed during use in either of the two fluoropolymer layers will not propagate into the adjacent layer, thus maintaining a dielectric surrounding the electrical conductors, protection of the electrical conductors against corrosion by H₂S and rapid gas decompression insensitivity. Since the fluoropolymer layers form the primary insulation of the electrical conductors, rapid gas decompression insensitivity is critical for the operability of the power cable. The fact that the primary insulation is in two layers (first and second layers of fluoropolymer) not adhered to one another does not detract from the decompression insensitivity of the fluoropolymer layers, individually and collectively.

The thicknesses of the first fluoropolymer layer apply to the combined thicknesses of the first and second fluoropolymer layers forming the primary insulation within the power cable. Preferably, the thickness of one of the two layers is within at least 20% of the thickness of the other layer. Preferably, the thickness of one of the two layers is essentially the same as the thickness of the other layer, taking into account thickness variation that can occur in the extrusion application of the layers to the electrical conductors and the second layer to the first layer. Preferably, the total insulation thickness is at least 0.75 mm and the thickness of each fluoropolymer layer is at least 0.38 mm. Typically, the combined thicknesses of the two layers will be no greater than 1.5 or 2 mm. In the case of non-circular second fluoropolymer layer, its layer thickness applies to the thinnest thickness of the layer.

The first and second fluoropolymer layer surrounding the electrical conductors may independently have a circular, oval, rectangular, square or other complex shape such as for example a first circular fluoropolymer layer surrounded by a second rectangular fluoropolymer layer, and they preferably have the same shape.

Preferably, the first and second fluoropolymer layers surrounding the electrical conductors have a circular or square shape, and preferably a circular shape.

In the ESP power cable according to the present invention, the first fluoropolymer layer is surrounded by a second fluoropolymer layer, which may be contiguous or not contiguous.

In the case where the first fluoropolymer layer is contiguous, the second fluoropolymer layer surrounding the first fluoropolymer layer is also a contiguous fluoropolymer layer.

In the case where the first fluoropolymer layer is not contiguous, i.e. each conductor has a separate jacket or sheath, the second fluoropolymer layer surrounding the first fluoropolymer layer may be a contiguous or not contiguous fluoropolymer layer, and is preferably not contiguous, i.e. each conductor has two concentric separate jackets or sheaths, or stated alternatively, each individual first fluoropolymer layer is encapsulated by an individual second fluoropolymer.

The first and second fluoropolymer layer surrounding the electrical conductors may be applied to the electrical conductor by known methods such as pressure melt extrusion, or tubing melt extrusion.

The first and second fluoropolymer layers may be applied simultaneously or sequentially onto the electrical conductor. Preferably, they are applied simultaneously.

In the case the ESP power cable according to the present invention includes a second fluoropolymer layer, the additional padding layer is preferably present in the cable, intercalated between the second fluoropolymer layer and the outer metal armouring. The padding layer can be the same as described above with the first fluoropolymer layer being in direct contact with the padding layer. In this two-layer insulation embodiment, the padding layer surrounds the second fluoropolymer layer. The padding layer is preferably in direct contact with the second fluoropolymer layer. The padding layer is also preferably in direct contact with the metal armouring and preferably with the second fluoropolymer layer as well.

The electrical submersible pump power cables for use in oil wells described in the present invention are advantageous in that they provide a power cable that does not require a layer of lead and therefore which has a substantially smaller weight per unit length and a smaller cross-section than a conventional ESP cable, while at the same time offering excellent electrical insulation for the electrical conductors, excellent chemical resistance and barrier against well gases and excellent fatigue (crack) resistance and lifetime.

The fluoropolymer primary insulation is rapid gas decompression resistant whether present in a single layer or as two layers of the same combined thickness.

### EXAMPLES

A layer (sheet) of PFA 0.5 mm thick is subjected to the decompression test of NORSOK M-710 simulating decompression in an armoured. The PFA has a melt flow index of 5.2 g/10 min and melting temperature of 305-310° C. The layer is placed in a holder, which in turn is placed in a pressurization cylinder which is heated to greater than 200° C. The cylinder is charged and pressurized with a gaseous composition which is 90% methane and 10% carbon dioxide to 5 000 psi (34.5 MPa). Decompression is carried out by release of the gaseous composition from the cylinder to obtain a pressure reduction of 1 000 psi/min (6.9 MPa/min). When the interior of the interior of the cylinder reaches atmospheric pressure, the PFA layer is removed and inspected. No evidence of decompression sensitivity is present, i.e. there is no change in layer thickness, indicating the absence of swelling of the layer during decompression as evidenced by there being no tearing or bubbling within the layer thickness. Examination of the cross-section of the PFA layer under magnification confirms this insensitivity.

The same result is obtained when the decompression test is repeated wherein the a layer of the same PFA that is 1 mm thick. The same result is obtained when the 1 mm thick layer is replaced by two 0.5 mm thick layers of the same PFA

The same result is obtained when the PFA is replaced by a 0.5 mm thick layer of FEP having a melt flow index of 5 g/10 min and melting temperature of 255-260° C. and by a 1 mm thick layer of the same FEP.

The MIT flex life of the PFA and FEP of these Examples each exceeds 20 000 cycles.

When this decompression test is practiced on a 1 mm thick layer of either EPDM or cross-linked polyethylene, the layer foams during decompression, which is evidenced by an irregular increase in layer thickness. The internal bubbles in the layer can be seen in the magnified cross-section of the layer after decompression. This test result is consistent with observations in the field when ESP power cable containing these primary insulations are subjected to rapid gas decompression.

In another experiment, the fluoropolymer layer is subjected to the wet electrical treeing test according to CEI-EIC 61956 standard, which determines whether arcing occurs on the surface of the layer under the application of 5 kV/mm for 240 hours to the layer submerged in a NaCl solution simulating brine-containing oil that may be encountered in the depth of the oil well. Arcing causes burn through of cable insulation. Neither samples of the PFA ad the FEP mentioned above in the decompression test causes such arcing, whereby these fluoropolymers pass this CEI-EIC stringent test.

A flat ESP power cable of the present invention, having the configuration of FIG. 5b, except that the insulation on the conductor is a single layer of fluoropolymer (the PFA described above) 1 mm thick and the outer metal armouring is helically wound stainless steel tape exhibits improved electrical and decompression performance as compared to a flat cable of the same number of electrical conductors, each insulated with a thicker EPDM insulation and each sheathed in lead and held together by a metal tape wrapping. The cable of the present invention measures only 28 mm in width as compared to 38 mm in width for the EPDM insulated cable and is lighter in weight by a factor (divisor) of 2.5. The fluoropolymer insulation in the power cable of the present invention provides better protection of the electrical conductors from H₂S than the combination of the EPDM insulation and lead sheath of the comparison cable.

What is claimed is:

1. An electrical submersible pump power cable for use in oil wells comprising
a. at least two electrical conductors
b. a first fluoropolymer layer surrounding each of the at least two electrical conductors
c. an outer metal armouring
wherein the first fluoropolymer layer surrounding each of the at least two electrical conductors comprises at least one fluoropolymer chosen among ETFE (ethylene tetrafluoroethylene copolymer), PFA (perfluoroalkoxy copolymer), FEP (fluorinated ethylene propylene copolymer) and/or mixtures thereof.

2. The electrical submersible pump power cable for use in oil wells according to claim 1, wherein the at least one fluoropolymer has a melt flow index of from 0.5 g/10 min to 10 g/10 min, as measured according to ISO 12086.

3. The electrical submersible pump power cable for use in oil wells according to claim 1, wherein the fluoropolymer of said first fluoropolymer layer has a stress crack resistance in excess of 20 000 cycles, when measured according to ASTM D 2176.

4. The electrical submersible pump power cable for use in oil wells according to claim 1, wherein the first fluoropolymer layer is in direct contact with the electrical conductors.

5. The electrical submersible pump power cable for use in oil wells according to claim 1, wherein the first fluoropolymer layer is in direct contact with each of said electrical conductors and with said outer metal armouring.

6. The electrical submersible pump power cable for use in oil wells according to claim 1, wherein said first fluoropolymer layer has a second fluoropolymer layer surrounding said first fluoropolymer layer.

7. The electrical submersible pump power cable for use in oil wells according to claim 6, wherein the fluoropolymer of said second fluoropolymer layer comprises the same fluoropolymer of which said first fluoropolymer is comprised.

8. The electrical submersible pump power cable for use in oil wells according to claim 6, wherein said first and second fluoropolymer layers are in direct contact with one another

9. The electrical submersible pump power cable for use in oil wells according to claim 1, wherein an additional padding layer is intercalated between the first fluoropolymer layer and the outer metal armouring.

10. An electrical submersible pump power cable for use in oil wells comprising
a. at least two electrical conductors,
b. a first fluoropolymer layer surrounding each of the at least two electrical conductors,
c. a second fluoropolymer layer surrounding the first fluoropolymer layer,
d. and an outer metal armouring
wherein the first fluoropolymer layer surrounding each of the at least two electrical conductors comprises at least one fluoropolymer chosen among ETFE (ethylene tetrafluoroethylene copolymers, PFA (perfluoroalkoxy copolymers), FEP (fluorinated ethylene propylene copolymers) and/or mixtures thereof, and wherein the second fluoropolymer layer surrounding the first fluoropolymer layer comprises at least one fluoropolymer chosen among ETFE (ethylene tetrafluoroethylene copolymer, PFA (perfluoroalkoxy copolymer), FEP (fluorinated ethylene propylene copolymer) and/or mixtures thereof.

11. The electrical submersible pump power cable for use in oil wells according to claim 10, wherein an additional padding layer is intercalated between the second fluoropolymer layer and the outer metal armouring.

12. The electrical submersible pump power cable for use in oil wells according to claim 10, wherein the first fluoropolymer layer is in direct contact with the electrical conductors and the second fluoropolymer layer and wherein the second fluoropolymer layer is in direct contact with the first fluoropolymer layer and the outer metal armouring.
